(19) United States
(12) Patent Application Publication
(10) Pub. No.: US 2025/0384027 A1
(43) Pub. Date: Dec. 18, 2025

(54) SYSTEM, METHOD, AND PROGRAM FOR EVALUATING PERFORMANCE OF CHART DE-RENDERING MODEL USING ARTIFICIAL INTELLIGENCE

(71) Applicant: LG MANAGEMENT DEVELOPMENT INSTITUTE CO., LTD., Seoul (KR)

(72) Inventors: Kwangrok RYOO, Seoul (KR); Seungjun LEE, Seoul (KR); Soonyoung LEE, Seoul (KR)

(21) Appl. No.: 19/305,978

(22) Filed: Aug. 21, 2025

Related U.S. Application Data
(63) Continuation of application No. PCT/KR2025/001511, filed on Jan. 24, 2025.

(30) Foreign Application Priority Data
Jan. 25, 2024 (KR) 10-2024-0011847

(51) Int. Cl. G06F 16/23

(52) U.S. Cl. CPC G06F 16/2365

(57) ABSTRACT

Provided is a system for implementing model for evaluating accuracy of a chart de-rendering model. The system includes one processor, and one memory storing instructions for the processor. The processor inputs a chart stored in test set into artificial intelligence (AI) model to output data format in which information of the chart is predicted, and inputs the data format into performance evaluation model to output performance evaluation result for the AI model by comparing information of the data format with ground truth (GT), which is stored in the test set. The performance evaluation result includes line accuracy indicating degree of proximity between the chart of the data format and the chart of the GT, and axis accuracy indicating degree of overlap between range in which the chart of the data format is distributed and range in which the chart of the GT is distributed on one axis of the chart.

### CROSS REFERENCE TO RELATED APPLICATION

This application is a Bypass Continuation of International Patent Application No. PCT/KR2025/001511, filed on Jan. 24, 2025, which claims priority from and the benefit of Korean Patent Application No. 10-2024-0011847, filed on Jan. 25, 2024, which is hereby incorporated by reference for all purposes as if fully set forth herein.

### BACKGROUND

### Field

Embodiments of the invention generally relate to a system, method, and program for evaluating the performance of a model that extracts information of a chart by de-rendering the chart, and more particularly, the invention relates to a system, a method, and a program for evaluating the performance of an artificial intelligence model capable of extracting information of a chart by de-rendering the chart.

### DISCUSSION OF THE BACKGROUND

Charts included in papers, reports, textbooks, and the like are generally generated through a process of transmitting data tables set as numbers and groups, code defining an overall layout (e.g., type, orientation, color/shape configuration), and the like to a rendering engine.

Chart de-rendering is a process opposite to chart rendering, and refers to an operation extracting key information by analyzing and grouping visual patterns or information of a chart, and extracting information about data (e.g., numbers, groups, etc.), information about chart layout, etc. from the key information.

As a representative prior art related to accuracy evaluation for information of the chart extracted as results of the chart de-rendering, relative number set similarity (RNSS) is disclosed (DePlot: One-shot visual language reasoning by plot-to-table translation, Fangyu Liu et al., 2023, page 3). When there are data points predicted through de-rendering and ground truth (GT) representing information of actual data points, first, the RNSS calculates a distance (D) between the GT and the closest predicted data point therefrom as follows.

$$D ( p , t ) = min ( 1 , \frac{‖ p - t ‖}{‖ t ‖} )$$

Here, the final accuracy evaluation score is calculated by summing all the distances (D) calculated as below, dividing the sum by the number of data points of the one having more data points among the predicted data or the GT, and then subtracting the value from 1.

$$RNSS = 1 - \frac{{\sum }_{i = 1}^{N} {\sum }_{j = 1}^{N} {X}_{ij} D ( {p}_{i} , {t}_{j} )}{max ( N , M )}$$

Although the RNSS has been proven to be useful for evaluating performance in data sets composed of a small number of data points, since it only considers the distance between data points without considering data indices, it has a limitation in accurately representing the characteristics of the chart.

For example, in FIG. 1A, the actual GT is a chart heading toward the lower right, but the AI model predicted a chart heading toward the upper right, and in FIG. 1B, the actual GT is a chart in which chart a is located below chart b, but the AI model predicted the positions of chart a and chart b in reverse. As such, in FIGS. 1A and 1B, even though the data predicted by the AI model does not match the GT, so the data is incorrectly predicted, since the sum of distances between points in the predicted data and points of the chart included in the GT may be zero, the RNSS, which does not consider the data indices, cannot distinguish this and may evaluate the accuracy about the predicted data as 100%. As depicted in FIG. 1C, since the first predicted data (triangular shape) is located on the GT (circular shape), the first predicted data (triangular shape) should be evaluated as more accurate than the second predicted data (quadrangular shape), but according to the RNSS, the first predicted data (triangular shape) and the second predicted data (quadrangular shape) are spaced by the same distance (D) from the GT (circular shape), so they are evaluated as having the same accuracy. Furthermore, in FIG. 1D, since Prediction 2 is visually closer to the GT value than Prediction 1, Prediction 2 should be evaluated as a more accurate prediction, but the RNSS evaluates the accuracy using only numbers (e.g., Y-axis values), so the accuracy of (A) and (B) is derived as the same.

The above information disclosed in this Background section is only for understanding of the background of the inventive concepts, and, therefore, it may contain information that does not constitute prior art.

### SUMMARY

An object of the invention is directed to providing a system, method, and program capable of objectively evaluating the performance of a model that extracts information of a chart by de-rendering the chart.

Objects of the invention are not limited to the above-described object, and other objects that are not mentioned will be clearly understood by those skilled in the art from the following description.

Additional features of the inventive concepts will be set forth in the description which follows, and in part will be apparent from the description, or may be learned by practice of the inventive concepts.

A system for evaluating the accuracy of a chart de-rendering model according to the embodiments of the invention may include at least one processor, and at least one memory storing instructions for execution by the at least one processor, in which the at least one processor is configured to input an image of a chart stored in a test set into an AI model to output a data format in which information of the chart is predicted, and input the data format into a performance evaluation model to output a performance evaluation result for the AI model by comparing information of the data format with ground truth (GT), which is information about the chart stored in the test set, and in which the performance evaluation result may include a line accuracy indicating a degree of proximity between the chart according to the information of the data format and the chart according to the GT, and an axis accuracy indicating a degree of overlap between a range in which the chart according to the information of the data format is distributed and a range in which the chart according to the GT is distributed on at least one axis of the chart.

In the system, the line accuracy may be a parameter obtained by fixing an axis area formed by an X-axis or a Y-axis of the chart according to the information of the data format and the chart according to the GT to a specific value, and comparing the axis area with an area between a line of the chart according to the information of the data format and a line of the chart according to the GT.

In the system, the degree of overlap of the axis accuracy may be a proportion that an overlapping part between a range of an X-axis on which the chart according to the information of the data format is distributed and a range of the X-axis on which the chart according to the GT is distributed in an entirety of the range of the X-axis on which the chart according to the information of the data format is distributed and the range of the X-axis on which the chart according to the GT is distributed.

In the system, the performance evaluation result may further include a meta accuracy, and the meta accuracy may be a degree of match between meta information included in the data format and meta information included in the GT.

In the system, the meta accuracy may be calculated using a character error rate (CER),
in which,

$$CER = \frac{( S + D + I )}{N} = \frac{( S + D + I )}{( S + D + C )}$$

(S denotes a number of substitution characters, D denotes a number of deletion characters, I denotes a number of insertion characters, C denotes a number of correct characters, and N denotes a total number of reference characters (=S+D+C)).

In the system, the performance evaluation result may further include a length accuracy, and the length accuracy may be a difference between a length of the chart according to the information of the data format and the length of the chart according to the GT.

A method for evaluating the accuracy of a chart de-rendering model according to the embodiments of the invention may include inputting an image of a chart stored in a test set into an image encoder to convert the image into a first embedding processable by an artificial intelligence (AI) model, inputting the first embedding into the AI model to output at least one data format including meta information or data information included in the image of the chart, and inputting the data format into a performance evaluation model to output a performance evaluation result by comparing information included in the data format with ground truth (GT) including information about the chart stored in the test set, in which the performance evaluation result may be determined according to a line accuracy indicating a degree of proximity between a line of a chart according to the information included in the data format and the line of the chart according to the GT, and an axis accuracy indicating a degree of overlap between a range in which the chart according to the information included in the data format is distributed and a range in which the chart according to the GT is distributed on at least one axis of the chart.

In the method, the line accuracy may be a parameter obtained by fixing an axis area formed by an X-axis or a Y-axis of the chart according to the information included in the data format and the chart according to the GT to a specific value, and comparing the axis area with an area between a line of the chart according to the information of the data format and the line of the chart according to the GT.

In the method, the degree of overlap of the axis accuracy may be a proportion that an overlapping part between a range of an X-axis on which the chart according to the information included in the data format is distributed and the range of the X-axis on which the chart according to the GT is distributed in an entirety of the range of the X-axis on which the chart according to the information included in the data format is distributed and the range of the X-axis on which the chart according to the GT is distributed.

In the method, the performance evaluation result may further include a meta accuracy, and the meta accuracy may be a degree of match between meta information included in the data format and meta information included in the GT.

In the method, the meta accuracy may be calculated using a character error rate (CER),
in which,

$$CER = \frac{( S + D + I )}{N} = \frac{( S + D + I )}{( S + D + C )}$$

(S denotes a number of substitution characters, D denotes a number of deletion characters, I denotes a number of insertion characters, C denotes a number of correct characters, and N denotes a total number of reference characters (=S+D+C)).

In the method, the performance evaluation result may further include a length accuracy, and the length accuracy may be a difference between a length of the chart according to the information included in the data format and the length of the chart according to the GT.

A program stored in a computer-readable recording medium, which, when executed by a computer, may cause the computer to perform a method comprising: inputting an image of a chart stored in a test set into an image encoder to convert the image into a first embedding processable by an artificial intelligence (AI) model; inputting the first embedding into the AI model to output at least one data format including meta information or data information included in the image of the chart; and inputting the data format into a performance evaluation model to output a performance evaluation result by comparing information included in the data format with ground truth (GT) including information about the chart stored in the test set, in which the performance evaluation result is determined according to: a line accuracy indicating a degree of proximity between a line of a chart according to the information included in the data format and the line of the chart according to the GT, and an axis accuracy indicating a degree of overlap between a range in which the chart according to the information included in the data format is distributed and a range in which the chart according to the GT is distributed on at least one axis of the chart.

According to the embodiments of the invention, the characteristics of a model can be quantitatively and objectively evaluated by separating and evaluating evaluation parameters having orthogonality.

According to the embodiments of the invention, how accurately the AI model predicts a shape of a chart can be objectively evaluated by indicating how closely lines of output charts are in contact with lines of charts included in GT under the same conditions between the AI models using a line accuracy.

According to the embodiments of the invention, how widely the AI model can predict the chart can be evaluated using the axis accuracy.

According to the embodiments of the invention, how correctly the AI model recognizes meta information can be objectively evaluated using a meta accuracy.

According to the embodiments of the invention, how evenly the AI model predicts the shape of the chart may be objectively evaluated using a length accuracy.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIGS. 1A, 1B, 1C, and 1D are schematic examples of chart de-rendering results that are subjects of performance evaluation.

FIG. 2 is a schematic diagram of a system for implementing a performance evaluation method of a chart de-rendering model using artificial intelligence according to one embodiment of the invention.

FIG. 3 is a schematic block diagram for explaining a configuration of a device performing the performance evaluation method of the chart de-rendering model using artificial intelligence according to one embodiment of the invention.

FIG. 4 is a schematic block diagram for explaining a method for evaluating the performance of an artificial intelligence model that de-renders a chart according to embodiments of the invention.

FIGS. 5A, 5B, 6, and 7 are schematic examples comparing charts output from an artificial intelligence (AI) model and charts included in GT.

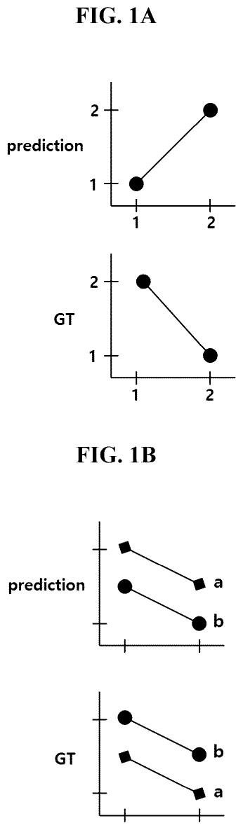

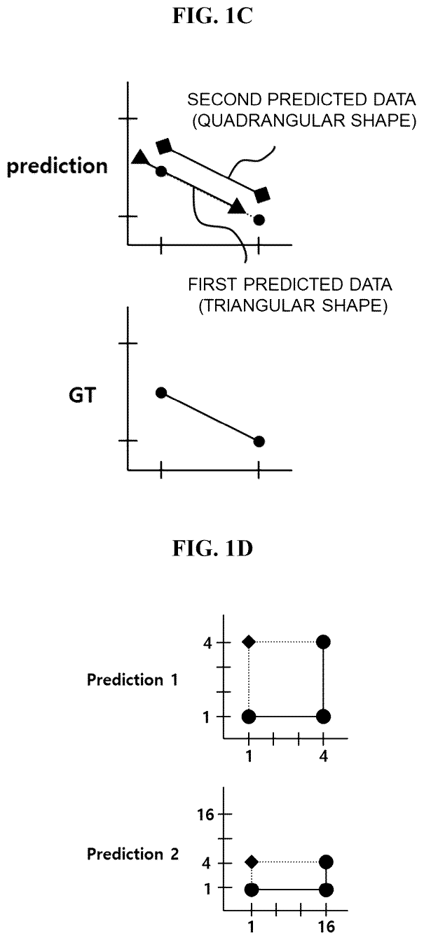

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard- wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

The following embodiments are provided as examples so that the spirit of the invention can be sufficiently conveyed to those skilled in the art to which the invention pertains. Therefore, the invention is not limited to the embodiments described below and may be specified in other forms.

The same reference numerals refer to the same components throughout the invention. The invention does not describe all elements of the embodiments, and common content in the art to which the invention pertains or content that overlaps between the embodiments will be omitted. Terms such as “unit,” “module,” “member,” and “block” used in the specification may be implemented as software or hardware, and according to the embodiments, a plurality of “units,” “modules,” “members,” and “blocks” may be implemented as one component, or one “unit,” “module,” “member,” and “block” may also include a plurality of components.

Throughout the specification, when a first component is described as being “connected” to a second component, this includes not only a case in which the first component is directly connected to the second component but also a case in which the first component is indirectly connected to the second component, and the indirect connection includes connection through a wireless communication network.

When a certain portion is described as “including” a certain component, it means further including other components rather than precluding other components unless specifically stated otherwise.

Throughout the specification, when a first member is described as being positioned “on” a second member, this includes both a case in which the first member is in contact with the second member and a case in which a third member is present between the two members.

Terms such as first and second are used to distinguish one component from another, and the components are not limited by the above-described terms.

A singular expression includes plural expressions unless the context clearly dictates otherwise.

In each operation, identification symbols are used for convenience of explanation, and the identification symbols do not describe the sequence of each operation, and each operation may be performed in a different sequence from the specified sequence unless a specific sequence is clearly described in context.

A system for evaluating performance of a chart de-rendering model according to the embodiments of the invention may include a device, and the device may include all types of devices capable of performing computation processing and providing results to a user. For example, the system for evaluating the performance of the chart de-rendering model according to the embodiments of the invention may include at least one of a computer, a server device, and a portable terminal, or may be implemented in any one form having the same or similar functions thereof. However, the invention is not limited thereto.

Here, the computer may include, for example, a notebook, a desktop, a laptop, a tablet PC, a slate PC, etc., which are equipped with a web browser.

The server device may be a server that processes information in communication with an external device, and may include an application server, a computing server, a database server, a file server, a game server, a mail server, a proxy server, and a web server.

The portable terminal may be, for example, a wireless communication device ensuring portability and mobility and may include all kinds of handheld-based wireless communication devices such as a personal communication system (PCS), a global system for mobile communications (GSM), a personal digital cellular (PDC), a personal handphone system (PHS), a personal digital assistant (PDA), international mobile telecommunication-2000 (IMT-2000), code division multiple access-2000 (CDMA-2000), w-code division multiple access (W-CDMA), a wireless broadband internet (WiBro) terminal, a smart phone, and wearable devices such as a watch, a ring, a bracelet, an anklet, a necklace, glasses, contact lenses, or a head-mounted device (HMD).

Hereinafter, embodiments of the invention will be described in detail with reference to the accompanying drawings.

The invention relates to a system, method, and program for evaluating the performance of a model that extracts information of a chart by de-rendering the chart, and more particularly, the invention relates to a system, a method, and a program for evaluating the performance of an artificial intelligence model capable of extracting information of a chart by de-rendering the chart.

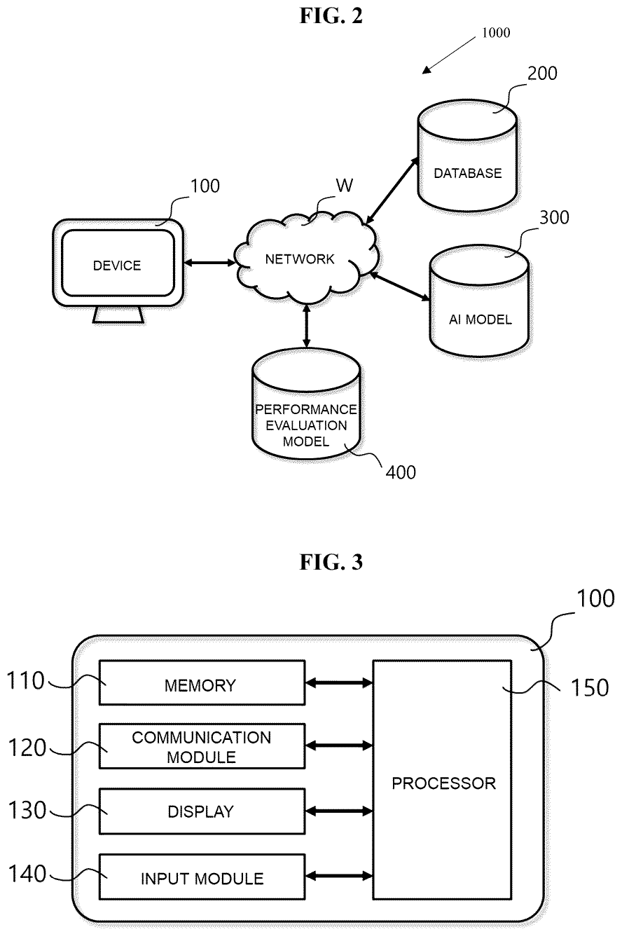

FIG. 2 is a schematic diagram of a system capable of implementing a method for evaluating the performance of a model that de-renders a chart according to one embodiment of the invention.

As depicted in FIG. 2, a system 1000 may include a device 100, a database 200, an AI model 300, and a performance evaluation model 400.

The device 100, the database 200, the AI model 300, and the performance evaluation model 400 included in the system 1000 may perform communication via a network W. Here, the network W may include a wired network and a wireless network. For example, the network may include various networks such as a local area network (LAN), a metropolitan area network (MAN), and a wide area network (WAN).

The network W may include the well-known world wide web (WWW). However, the network W according to embodiments of the invention is not limited to the above-listed networks and may include, at least in part, a well-known wireless data network, a well-known telephone network, or a well-known wired and wireless television network.

The device 100 may input the chart into the AI model 300 and output information about the chart, and may evaluate the performance of the AI model 300 using the performance evaluation model 400 based on the output information about the chart.

A test set composed of an image of the chart including text, lines, etc., ground truth (GT) including information about the chart, and the like may be input into the AI model 300.

The GT may refer to the accurate and verified information used as a benchmark for training or evaluating machine learning models. The test set may be the same as what is generally used to train the AI model or evaluate its performance, but is not limited thereto. A form of the chart included in the test set may include a vertical/horizontal bar chart, a line chart, a pie chart, an area chart, a scatter chart, a radar chart, a histogram, and/or a waterfall chart. The form of the chart may be a single form or a combined form of a plurality of forms. However, the chart used in the invention is not limited thereto, and the chart may include any form of chart. The chart may include text information in addition to information (e.g., a line, a circle, etc.) that visualizes numerical values, etc., and specifically, may include annotation information of the chart, a legend or title of the chart, a name of each axis (e.g., an X-axis, a Y-axis, a Z-axis, etc.), numerical values of raw data of points included in the chart (e.g., numerical values of the X-axis and the Y-axis of points included in the chart), etc.

The information about the chart output from the AI model 300 may be information that represents features of the chart and include meta information, data information, etc. The meta information may include names of the X-axis and Y-axis, a name of an entity group recorded in the legend, etc. The data information may include numerical values of the X-axis and/or Y-axis of each entity, etc.

The information about the chart output from the AI model 300 may be input into the performance evaluation model 400, and the performance evaluation model 400 may evaluate the performance of the AI model 300 by comparing the output information about the chart with the GT included in the data set.

A performance evaluation result output from the performance evaluation model 400 may indicate how the AI model accurately predicts the chart. The performance evaluation result may be represented as a score expressed in numerical form, a diagram expressed in image form, and the like, but is not limited thereto. The performance evaluation result may be separately output for each individual parameter value, and the individual parameter values may include a line accuracy, an axis accuracy, a meta accuracy, or a length accuracy, but are not limited thereto.

According to the embodiments of the invention, the device 100 may output a performance evaluation result for the AI model that de-renders the input chart.

The database 200 may store various data (e.g., a test set) for training the AI model 300 or evaluating its performance. The database 200 may store a chart image, the information about the chart, information about a performance evaluation method, etc., and in various embodiments, may also store output data output by the AI model 300. However, the system 1000 may not include the database 200 when the training of the AI model 300 is completed.

The database 200 may be implemented outside the device 100. In this case, the database 200 may be connected to the device 100 in a wired or wireless communication manner. However, it is not limited thereto, and the database 200 may also be implemented as one component of the device 100.

The AI model 300 may be implemented outside the device 100 (e.g., implemented in a cloud-based manner), but is not limited thereto, and may be implemented as one component of the device 100.

FIG. 3 is a schematic block diagram for explaining a configuration of a device that performs a method for evaluating the performance of an artificial intelligence (AI) model capable of extracting information of the chart by de-rendering the chart according to one embodiment of the invention.

As depicted in FIG. 3, the device 100 may include a memory 110, a communication module 120, a display 130, an input module 140, and a processor 150. However, the invention is not limited thereto, and software and hardware components of the device 100 may be modified/added/omitted according to a required operation within a scope obvious to those skilled in the art. The device 100 may be replaced with a system, and the device 100 may include a plurality of devices, and in this case, each component included in the device 100 may be included in at least one of the plurality of devices.

The memory 110 may store data supporting various functions of the device 100 and a program for the operation of the processor 150, store input/output data, and store a plurality of application programs or applications that are driven on the present device, data, command, and the AI model for the operation of the device 100. At least some of the application programs may be downloaded from an external server (or cloud server) via wireless communication.

Such memory 110 may include at least one type of storage medium among a flash memory type, a hard disk type, a solid state disk type (SSD type), a silicon disk drive type (SDD type), a multimedia card micro type, a card-type memory (e.g., an SD or XD memory), a random access memory (RAM), a static random access memory (SRAM), a read-only memory (ROM), an electrically erasable programmable ROM (EEPROM), a programmable ROM (PROM), a magnetic memory, a magnetic disk, and an optical disk.

The memory 110 may be separated from the device, and may include a database that is connected in a wired or wireless communication manner. The database 200 shown in FIG. 2 may be implemented as one component of the memory 110.

The communication module 120 may include one or more components that enable communication with an external device, and may include at least one of, for example, a broadcasting reception module, a wired communication module, a wireless communication module, a short-range communication module, or a position information module.

The wired communication module may include not only various wired communication modules such as a local area network (LAN) module, a wide area network (WAN) module, and a value added network (VAN) module, but also various cable communication modules such as a universal serial bus (USB), a high definition multimedia interface (HDMI), a digital visual interface (DVI), a recommended standard 232 (RS-232), power line communication, and plain old telephone service (POTS).

In addition to the WiFi module and the wireless broadband (WiBro) module, the wireless communication module may include a wireless communication module for supporting various wireless communication methods such as global system for mobile communication (GSM), code division multiple access (CDMA), wideband CDMA (WCDMA), universal mobile telecommunications system (UMTS), time division multiple access (TDMA), long term evolution (LTE), 4G, 5G, or 6G.

The display 130 may display (or output) information or data that are processed in the device 100, data that are input or output through the AI model 300, etc. The display 130 may display execution screen information of an application program (e.g., an application) driven on the device 100, or user interface (UI) or graphic user interface (GUI) information according to such execution screen information.

The input module 140 may receive information from a user, and when the user inputs information through an input unit, the processor 150 may control the operation of the device 100 to correspond to the input information.

The input module 140 may include a hardware physical key (e.g., a button located on at least one of a front surface, a back surface, and a side surface of the device, a dome switch, a jog wheel, a jog switch, etc.) and a software touch key. For example, the touch key may be formed as a virtual key, a soft key, or a visual key that is displayed on a touchscreen type of the display 130 through software processing or may be formed as the touch key disposed in a portion other than the touchscreen. Meanwhile, the virtual key or visual key may have various forms and may be displayed on the touchscreen, and may be formed as, for example, a graphic, text, an icon, a video, or a combination thereof.

The processor 150 may be located adjacent to the memory 110, the communication module 120, the display 130, and the input module 140 and may be electrically connected to the memory 110, the communication module 120, the display 130, and the input module 140. The processor 150 may be implemented with the memory 110 that stores data for an algorithm for controlling the operations (including training or execution of the AI model) of the components in the device 100 or a program that reproduces the algorithm, and at least one processor (not shown) that performs the above-described operation using the data stored in the memory. In this case, the memory 110 and the processor 150 may be implemented as separated chips or may be implemented as a single chip.

In one embodiment, the system 1000 or the device 100 according to the embodiments of the invention may include at least one processor. In another embodiment, the system 1000 or the device 100 according to the embodiments of the invention may include more than one processor, and when including a plurality of processors, the plurality of processors may be included in different devices 100.

The processor 150 may control the operations of the components by combining any one or a plurality of the above-described components in order to implement various embodiments according to the embodiments of the invention, which will be described below, on the device 100.

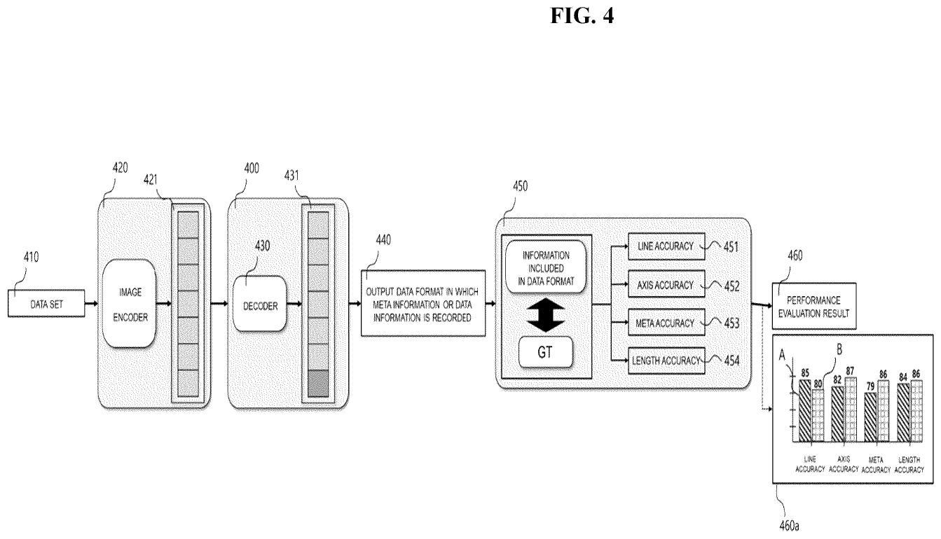

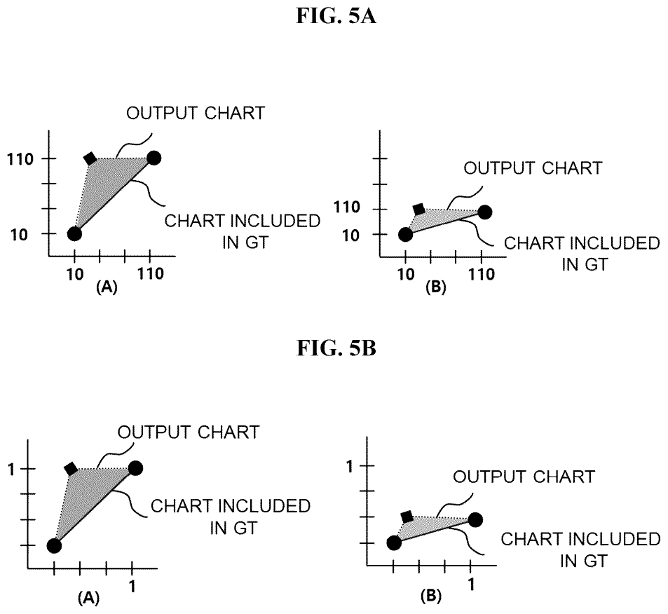

FIG. 4 is a schematic block diagram for explaining a method for evaluating the performance of a model that extracts the information of the chart by de-rendering the chart according to an embodiment of the invention. FIGS. 5 to 7 are schematic examples comparing charts output from an AI model and charts included in GT.

Referring to FIG. 4, a test set 410 composed of an image of the chart including text, lines, etc. and ground truth (GT) including information about the chart, may be input into an image encoder 420. Here, the image of the chart may include a title of the chart, an axis name, legend information, numerical values, and the like. A form of the chart 410 may be a vertical/horizontal bar chart, a line chart, a pie chart, an area chart, a scatter chart, a radar chart, a histogram, and/or a waterfall chart, but is not limited thereto. The form of the chart may be a single form or a combined form of a plurality of forms.

The image encoder 420 may follow a generally used encoder architecture and serve to convert the input chart 410a into a first embedding 421 that is processed by the AI model 300. Here, the first embedding 421 may include a concatenate embed.

Next, the first embedding 421 output from the image encoder 420 may be input into the AI model 300 including a decoder 430 that performs meta decoding, data decoding, and the like. The decoder 430 may decode the first embedding 421 to extract meta information (e.g., chart title, X-axis name, Y-axis name, legend), data information (e.g., data point numerical values, etc.) of the chart, and the like, and outputs the meta information and the data information as a second embedding 431.

As such, the AI model 300 may ultimately output a data format 440 including the meta information, the data information, and the like, from the output second embedding 431.

Next, the data format 440 output from the AI model may be input into a chart de- rendering performance evaluation model 450. The chart de-rendering performance evaluation model 450 may compare the information of the chart in the data format 440 (e.g., chart title, X-axis name, Y-axis name, legend, data point numerical values, etc.) with the GT included in the data set 410, and may calculate parameter values for deriving a performance evaluation result 460 according to a predetermined method. The calculated parameter values may reflect information about data indices, and specifically may include a line accuracy 451, an axis accuracy 452, a meta accuracy 453, a length accuracy 454, etc., but are not limited thereto.

The performance evaluation model 450 may individually or collectively generate (or output) the calculated parameter values as the performance evaluation result 460 indicating how the AI model accurately predicts the chart. The performance evaluation result 460 may be represented as a score expressed in a numerical form, a graph expressed in an image form, and the like, but is not limited thereto. The performance evaluation result 460 may be separately output for each individual parameter value, and the individual parameter values may include the line accuracy 451, the axis accuracy 452, the meta accuracy 453, or the length accuracy 454, etc. described above, but are not limited thereto. For example, the performance evaluation result 460 may be represented as a performance evaluation result 460a.

Therefore, according to the embodiments of the invention, the characteristics of the model may be quantitatively and objectively evaluated by separating and evaluating evaluation parameters having orthogonality.

Hereinafter, the parameter values used to derive the performance evaluation result 460 will be described in detail with reference to FIGS. 5A, 5B, 6, and 7.

The line accuracy 451 may be a parameter indicating a degree of proximity between a line of the chart output from the AI model and a line of the chart included in the GT, and through the line accuracy 451, how accurately the AI model predicts a shape of the chart may be evaluated. Specifically, the line accuracy 451 may be a parameter obtained by fixing an area (axis area) formed by an X-axis or a Y-axis of the chart to a specific value (e.g., fixing the area of the X-axis*Y-axis of the chart to 1*1), and comparing a value of the corresponding area value with an area between the line of the output chart and the line of the chart included in the GT.

More specifically, referring to the example shown in FIG. 5A of comparing charts output from AI model (A) and AI model (B) with the chart included in the GT, it can be seen that model B, in which the line of the chart output from the AI is closer to the line of the chart included in the GT, predicts the shape of the chart more accurately than model A. However, when calculating the area (i.e., a part marked with a triangular shadow in the chart) between the line of the chart output from each of AI model (A) and AI model (B) and the line of the chart included in the GT using the X-axis and Y-axis values, this area may appear the same in both models. As such, when the area formed by the X-axis or the Y-axis of the chart output from AI model (A) and AI model (B) is not fixed, the area between the line of the output chart and the line of the chart included in the GT may not be compared under the same conditions due to the difference in scales of the X-axis or the Y-axis. Furthermore, due to this, it is difficult to compare which AI model more accurately predicts the shape of the chart.

To solve this problem, as depicted in FIG. 5B, for the charts output from AI model (A) and AI model (B), the area formed by the X-axis or the Y-axis may identically be fixed to a constant (=1*1). The line accuracy 451 may be calculated using the proportion that the area (a part marked with a triangular shadow in the chart) between the line of the output chart and the line of the chart included in the GT occupies in the fixed chart area (=1). By calculating and comparing the line accuracy 451 for each AI model in this way, it is possible to compare under the same conditions how closely the line of the chart output from each AI model is in contact with the line of the chart included in the GT (i.e., how small the proportion of the area separated between the charts is in the total area).

More preferably, the line accuracy 451 may be calculated by the following equation.

$$Line Accuracy = \{ \begin{matrix}1 - {\int }_{i} [ P - T ] dx & if i = ∅ \\ otherwise & 0\end{matrix} , I = dom ( P ) ⋂ dom ( T )$$

Here, P denotes the function followed by the output chart, and T denotes the function followed by the chart included in the GT. In addition, dom denotes the domain followed by each function (P and T). According to the above equation, the line accuracy 451 may be calculated by subtracting the area (a part with a triangular shadow) formed between the line of the output chart and the line of the chart included in the GT from the area (in the case of FIG. 5B, “1”) formed by the X-axis or the Y-axis of the chart, and the model with a greater value of the line accuracy 451 may be evaluated as having more accurate performance in predicting the shape of the chart. For example, in FIGS. 5A and 5B, since the area (a part with a triangular shadow) between the charts compared to the total area (1) is smaller in model B than in model A, a value of the line accuracy 451 is greater in model B, and accordingly, model B may be evaluated as predicting the shape of the chart more accurately than model A.

Therefore, according to the embodiments of the invention, how accurately the AI model predicts the shape of the chart may be objectively evaluated by indicating how closely the lines of the output charts are in contact with the lines of the charts included in the GT under the same conditions between the AI models using the line accuracy 451.

Meanwhile, the axis accuracy 452 may be a parameter indicating a degree of overlap between a range in which the chart output from the AI model is distributed and a range in which the chart included in the GT is distributed on at least one axis of the chart, and through the axis accuracy 452, whether the output chart is predicting the chart in a sufficient range may be evaluated. Even when the output chart is predicted to be adjacent to the chart included in the GT, the corresponding AI model may not provide useful values over a wide range when a range followed by the output chart is not wide. Therefore, it is necessary to evaluate whether the AI model predicts the chart over a sufficient range using the axis accuracy 452.

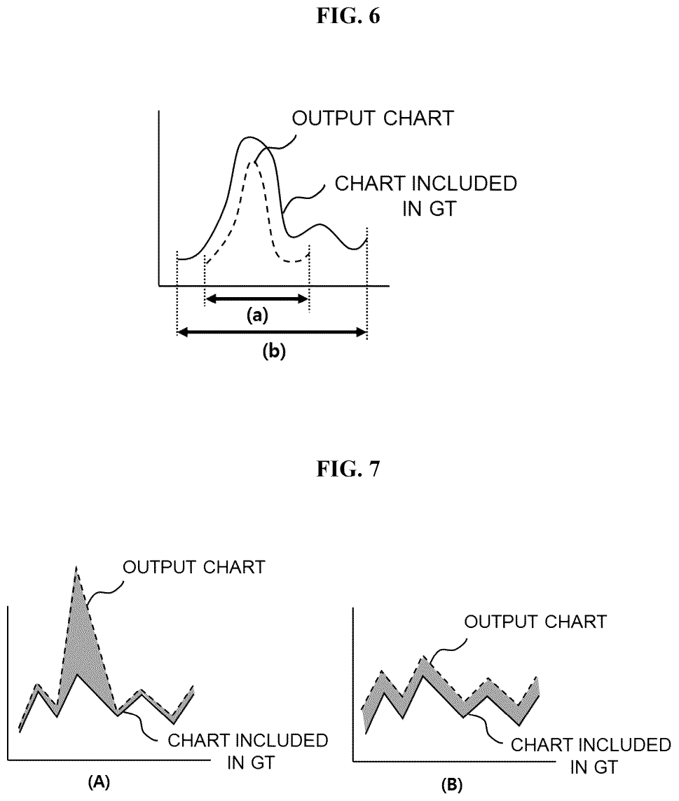

More specifically, as depicted in FIG. 6, a value of the axis accuracy 452 may be calculated as the proportion that the overlapping part (a) of a range of the X-axis in which the chart output from the AI model is distributed and a range of the X-axis in which the chart included in the GT is distributed occupies in the entirety (b) of the range of the X-axis in which the chart output from the AI model is distributed and the range of the X-axis in which the chart included in the GT is distributed (i.e., the higher the value of the axis accuracy 452, the wider the range over which the AI model may be evaluated to predict the chart).

More preferably, the line accuracy may be calculated by the following equation.

$$Axis Accuracy = \frac{m ( dom ( P ) ⋂ dom ( T ) )}{m ( dom ( P ) ⋃ dom ( T ) )}$$

Here, P denotes the function followed by the output chart, and T denotes the function followed by the chart included in the GT. In addition, dom denotes the domain followed by each function (P and T), and m denotes a Lebesgue measure. According to the above equation, the axis accuracy 452 may be calculated as the proportion that the overlapping part of the range of the X-axis in which the chart output from the AI model is distributed and the range of the X-axis in which the chart included in the GT is distributed occupies in the entirety of the range of the X-axis in which the chart output from the AI model is distributed and the range of the X-axis in which the chart included in the GT is distributed.

Therefore, according to the embodiments of the invention, how widely the AI model can predict the chart may be evaluated using the axis accuracy 452.

Meanwhile, the meta accuracy 453 may be a parameter value for evaluating whether the meta information of the chart output from the AI model has been correctly recognized. The meta (e.g., chart title, axis label, legend, etc.) information included in the output from the chart de-rendering AI model plays an important role in providing insights to a user using the output result, so it is necessary to evaluate how the AI model correctly recognizes the meta information.

Preferably, the meta accuracy 453 may be calculated using a character error rate (CER). The CER may be calculated as follows.

$$CER = \frac{( S + D + I )}{N} = \frac{( S + D + I )}{( S + D + C )}$$

Here, S denotes the number of substitution characters, D denotes the number of deletion characters, I denotes the number of insertion characters, C denotes the number of correct characters, and N denotes the total number of reference characters (=S+D+C). According to this, a lower CER value indicates a better recognition rate, and when the meta information is perfectly recognized, the CER is 0.

More specifically, the meta accuracy 453 may be calculated using the CER as follows.

$$Meta Accuracy = 1 - min ( 1 , CER ( {S}_{p} , {S}_{t} ) )$$

According to this, the higher the meta accuracy 453, the more accurately the AI model may be evaluated as predicting the meta information.

Therefore, according to the embodiments of the invention, how the AI model correctly recognizes the meta information may be objectively evaluated using the meta accuracy 453.

Meanwhile, the length accuracy 454 may be a parameter indicating whether the chart output from the AI model significantly deviates from the chart included in the GT at a specific point, and through the length accuracy 454, how accurately the AI model predicts the shape of the chart may be evaluated.

Specifically, referring to FIG. 7, the chart output from AI model (A) may significantly deviate from the chart included in the GT at a specific point, while AI model (B) almost exactly follows the shape of the chart included in the GT. Accordingly, AI model (B) may be evaluated as predicting the shape of the chart more accurately. In order to more accurately evaluate the performance of the AI model reflecting this point, the length accuracy 454 reflecting the difference in length between the chart output from the AI model and the chart included in the GT may additionally be considered in the performance evaluation result. That is, by assigning a higher length accuracy 454 as the difference in length between the output chart and the chart included in the GT becomes smaller, whether the AI model evenly predicts the shape of the chart may be evaluated. For example, in FIG. 7, since a length of the chart of AI model (B) is shorter than length of the chart of AI model (A), a value of accuracy 454 may be greater, and accordingly, AI model (B) may be evaluated as more evenly predicting the shape of the chart than AI model (A).

Preferably, the length accuracy 454 may be calculated by the following equation.

$$Length Accuracy = max ( 0 , 1 - \frac{\vert {L}_{P} - {L}_{T} \vert}{{L}_{T}} )$$

$$\{ \begin{matrix}{L}_{P} = {\int }_{I} \sqrt{1 + {\{ {P}^{′} ( x ) \}}^{2}} dx \\ {L}_{T} = {\int }_{I} \sqrt{1 + {\{ {T}^{′} ( x ) \}}^{2}} dx \\ I = dom ( P ) ⋂ dom ( T )\end{matrix}$$

Here, P denotes the function followed by the output chart, and T denotes the function followed by the chart included in the GT. In addition, dom denotes the domain followed by each function (P and T). According to the above equation, the length accuracy 454 may be calculated by subtracting the sum of the length (L_{P}) of the output chart and the length (L_{T}) of the chart included in the GT from 1, and the model with a greater value of the length accuracy 454 may be evaluated as having more accurate performance in evenly predicting the shape of the chart.

Therefore, according to embodiments of the invention, how the AI model evenly predicts the shape of the chart may be objectively evaluated using the length accuracy 454.

Meanwhile, the method for evaluating the performance of the model that extracts the information of the chart by de-rendering the chart, according to embodiments of the invention may be implemented by the system described with reference to FIG. 4.

AI models according to embodiments of the invention may be controlled, executed, trained, driven, etc. by the processor, and accordingly, at least one of the tasks of executing, training, and driving the AI models may be performed by at least one processor. The AI models may be stored in the memory, and the feature data according to embodiments of the invention may also be stored in memory.

Meanwhile, disclosed embodiments may be implemented in the form of a recording medium in which computer-executable commands are stored. The commands may be stored in the form of program code, and when executed by the processor, program modules may be generated to perform operations of the disclosed embodiments. The recording medium may be implemented as a computer-readable recording medium.

The computer-readable recording medium includes all types of recording media in which computer-decodable commands are stored. For example, there may be a read only memory (ROM), a random access memory (RAM), a magnetic tape, a magnetic disk, a flash memory, an optical data storage device, and the like.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be 10 apparent to a person of ordinary skill in the art.

What is claimed is:

1. A system for implementing a model for evaluating accuracy of a chart de-rendering model, the system comprising:
at least one processor; and
at least one memory storing instructions for execution by the at least one processor, wherein the at least one processor is configured to:
input an image of a chart stored in a test set into an artificial intelligence (AI) model to output a data format in which information of the chart is predicted; and
input the data format into a performance evaluation model to output a performance evaluation result for the AI model by comparing information of the data format with ground truth (GT), which is information about the chart stored in the test set, and
wherein the performance evaluation result includes:
a line accuracy indicating a degree of proximity between the chart according to the information of the data format and the chart according to the GT; and
an axis accuracy indicating a degree of overlap between a range in which the chart according to the information of the data format is distributed and a range in which the chart according to the GT is distributed on at least one axis of the chart.

2. The system of claim 1, wherein the line accuracy is a parameter obtained by fixing an axis area formed by an X-axis or a Y-axis of the chart according to the information of the data format and the chart according to the GT to a specific value, and comparing the axis area with an area between a line of the chart according to the information of the data format and a line of the chart according to the GT.

3. The system of claim 1, wherein the degree of overlap of the axis accuracy is a proportion that an overlapping part between a range of an X-axis on which the chart according to the information of the data format is distributed and a range of the X-axis on which the chart according to the GT is distributed in an entirety of the range of the X-axis on which the chart according to the information of the data format is distributed and the range of the X-axis on which the chart according to the GT is distributed.

4. The system of claim 1, wherein the performance evaluation result further includes a meta accuracy, and
the meta accuracy is a degree of match between meta information included in the data format and meta information included in the GT.

5. The system of claim 4, wherein the meta accuracy is calculated using a character error rate (CER), and
wherein,
$$CER = \frac{( S + D + I )}{N} = \frac{( S + D + I )}{( S + D + C )}$$
(S denotes a number of substitution characters, D denotes a number of deletion characters, I denotes a number of insertion characters, C denotes a number of correct characters, and N denotes a total number of reference characters (=S+D+C)).

6. The system of claim 1, wherein the performance evaluation result further includes a length accuracy, and
the length accuracy is a difference between a length of the chart according to the information of the data format and the length of the chart according to the GT.

7. A method for implementing a model for evaluating accuracy of a chart de-rendering model, the method comprising:
inputting an image of a chart stored in a test set into an image encoder to convert the image into a first embedding processable by an artificial intelligence (AI) model;
inputting the first embedding into the AI model to output at least one data format including meta information or data information included in the image of the chart; and
inputting the data format into a performance evaluation model to output a performance evaluation result by comparing information included in the data format with ground truth (GT) including information about the chart stored in the test set.
wherein the performance evaluation result is determined according to:
a line accuracy indicating a degree of proximity between a line of a chart according to the information included in the data format and the line of the chart according to the GT, and
an axis accuracy indicating a degree of overlap between a range in which the chart according to the information included in the data format is distributed and a range in which the chart according to the GT is distributed on at least one axis of the chart.

8. The method of claim 7, wherein the line accuracy is a parameter obtained by fixing an axis area formed by an X-axis or a Y-axis of the chart according to the information included in the data format and the chart according to the GT to a specific value, and comparing the axis area with an area between a line of the chart according to the information of the data format and the line of the chart according to the GT.

9. The method of claim 7, wherein the degree of overlap of the axis accuracy is a proportion that an overlapping part between a range of an X-axis on which the chart according to the information included in the data format is distributed and the range of the X-axis on which the chart according to the GT is distributed in an entirety of the range of the X-axis on which the chart according to the information included in the data format is distributed and the range of the X-axis on which the chart according to the GT is distributed.

10. The method of claim 7, wherein the performance evaluation result further includes a meta accuracy, and
the meta accuracy is a degree of match between meta information included in the data format and meta information included in the GT.

11. The method of claim 10, wherein the meta accuracy is calculated using a character error rate (CER), and
wherein,
$$CER = \frac{( S + D + I )}{N} = \frac{( S + D + I )}{( S + D + C )}$$
(S denotes a number of substitution characters, D denotes a number of deletion characters, I denotes a number of insertion characters, C denotes a number of correct characters, and N denotes a total number of reference characters (=S+D+C)).

12. The method of claim 7, wherein the performance evaluation result further includes a length accuracy, and
the length accuracy is a difference between a length of the chart according to the information included in the data format and the length of the chart according to the GT.

13. A program stored in a computer-readable recording medium, which, when executed by a computer, causes the computer to perform a method comprising:
inputting an image of a chart stored in a test set into an image encoder to convert the image into a first embedding processable by an artificial intelligence (AI) model;
inputting the first embedding into the AI model to output at least one data format including meta information or data information included in the image of the chart; and
inputting the data format into a performance evaluation model to output a performance evaluation result by comparing information included in the data format with ground truth (GT) including information about the chart stored in the test set,
wherein the performance evaluation result is determined according to:
a line accuracy indicating a degree of proximity between a line of a chart according to the information included in the data format and the line of the chart according to the GT, and
an axis accuracy indicating a degree of overlap between a range in which the chart according to the information included in the data format is distributed and a range in which the chart according to the GT is distributed on at least one axis of the chart.

14. The program of claim 13, wherein the line accuracy is a parameter obtained by fixing an axis area formed by an X-axis or a Y-axis of the chart according to the information included in the data format and the chart according to the GT to a specific value, and comparing the axis area with an area between a line of the chart according to the information of the data format and the line of the chart according to the GT.

15. The program of claim 13, wherein the degree of overlap of the axis accuracy is a proportion that an overlapping part between a range of an X-axis on which the chart according to the information included in the data format is distributed and the range of the X-axis on which the chart according to the GT is distributed in an entirety of the range of the X-axis on which the chart according to the information included in the data format is distributed and the range of the X-axis on which the chart according to the GT is distributed.

16. The program of claim 13, wherein the performance evaluation result further includes a meta accuracy, and
the meta accuracy is a degree of match between meta information included in the data format and meta information included in the GT.

17. The program of claim 16, wherein the meta accuracy is calculated using a character error rate (CER), and
wherein,
$$CER = \frac{( S + D + I )}{N} = \frac{( S + D + I )}{( S + D + C )}$$
(S denotes a number of substitution characters, D denotes a number of deletion characters, I denotes a number of insertion characters, C denotes a number of correct characters, and N denotes a total number of reference characters (=S+D+C)).
